(19) United States
(12) Patent Application Publication
(10) Pub. No.: US 2025/0043830 A1
(43) Pub. Date: Feb. 6, 2025

(54) FLEXIBLE SHAFT COUPLING

(71) Applicant: Mitsubishi Electric Corporation, Chiyoda-ku, Tokyo (JP)

(72) Inventor: Shinsaku MAEDA, Tokyo (JP)

(73) Assignee: Mitsubishi Electric Corporation, Chiyoda-ku, Tokyo (JP)

(21) Appl. No.: 18/719,964

(22) PCT Filed: Mar. 11, 2022
(86) PCT No.: PCT/JP2022/011000

§ 371 Date: Jun. 14, 2024

(51) Int. Cl. F16D 3/18

(52) U.S. Cl. CPC F16D 3/185

(57) ABSTRACT

A flexible shaft coupling includes a first gear and a second gear meshing with the first gear. The first gear has a first tooth surface, the second gear has a second tooth surface, and at least one of the first tooth surface or the second tooth surface is curved outward when viewed in a tooth trace direction.

### TECHNICAL FIELD

The present disclosure relates to a flexible shaft coupling.

### BACKGROUND ART

A railway vehicle includes electric motors mounted on a bogie to transmit power to the axles of the wheels. While the railway vehicle is traveling, the bogie shakes under disturbance vibrations, possibly causing misalignment between the drive shafts of the electric motors and the axles. To accommodate such misalignment between the drive shafts and the axles and transmit power from the electric motors to the axles, flexible shaft couplings are located between the drive shafts of the electric motors and the axles. For example, Patent Literature 1 describes a gear flexible coupling that accommodates relative displacement on a parallel-cardan steering bogie while the bogie is being steered. The gear flexible coupling in Patent Literature 1 includes gears with an involute profile.

### CITATION LIST

### Patent Literature

Patent Literature 1: Unexamined Japanese Patent Application Publication No. 2019-011773

### SUMMARY OF INVENTION

### Technical Problem

To accommodate greater relative displacement using external and internal gears with an involute profile, the contact areas between these gears are to be smaller, thus causing greater contact stress.

Under such circumstances, an objective of the present disclosure is to reduce the contact stress in a flexible shaft coupling.

### Solution to Problem

To achieve the above objective, a flexible shaft coupling according to an aspect of the present disclosure includes a first gear and a second gear meshing with the first gear. The first gear has a first tooth surface, the second gear has a second tooth surface, and at least one of the first tooth surface or the second tooth surface is curved outward when viewed in a tooth trace direction.

### Advantageous Effects of Invention

In the flexible shaft coupling according to the above aspect of the present disclosure, at least one of the first tooth surface of the first gear or the second tooth surface of the second gear is curved outward when viewed in the tooth trace direction. This reduces the contact stress in the flexible shaft coupling.

### BRIEF DESCRIPTION OF DRAWINGS

FIG. 1 is a plan view of a bogie in a railway vehicle including a flexible shaft coupling according to Embodiment 1;

FIG. 2 is a perspective view of the flexible shaft coupling according to Embodiment 1;

FIG. 3 is a schematic diagram of the flexible shaft coupling according to Embodiment 1, illustrating the internal structure;

FIG. 4 is a partial perspective view of an external gear in Embodiment 1;

FIG. 5 is a schematic diagram of an external tooth of the external gear and an internal tooth of an internal gear in Embodiment 1, illustrating the positional relationship between the teeth;

FIG. 6 is a schematic diagram of the external tooth of the external gear and the internal tooth of the internal gear in Embodiment 1, illustrating the positional relationship between the teeth;

FIG. 7 is a schematic cross-sectional view of the internal tooth of the internal gear and the external tooth of the external gear in Embodiment 1;

FIG. 8 is a schematic cross-sectional view of the internal tooth of the internal gear and the external tooth of the external gear in Embodiment 1;

FIG. 9 is a schematic cross-sectional view of an internal tooth of an internal gear and an external tooth of an external gear in Modification 1 of Embodiment 1;

FIG. 10 is a schematic cross-sectional view of an internal tooth of an internal gear and an external tooth of an external gear in Modification 2 of Embodiment 1;

FIG. 11 is a schematic cross-sectional view of an internal tooth of an internal gear in Embodiment 2;

FIG. 12 is a diagram of the internal tooth in FIG. 11, illustrating an internal-tooth pitch point and a nearby area in an enlarged manner;

FIG. 13 is a schematic cross-sectional view of an external tooth of an external gear in Embodiment 2;

FIG. 14 is a schematic cross-sectional view of the external tooth of the external gear in Embodiment 2; and

FIG. 15 is a schematic cross-sectional view of the internal tooth of the internal gear and the external tooth of the external gear in Embodiment 2.

### DESCRIPTION OF EMBODIMENTS

A flexible shaft coupling according to one or more embodiments of the present disclosure is described with reference to the drawings. Components identical or corresponding to each other are provided with the same reference sign in the drawings.

### Embodiment 1

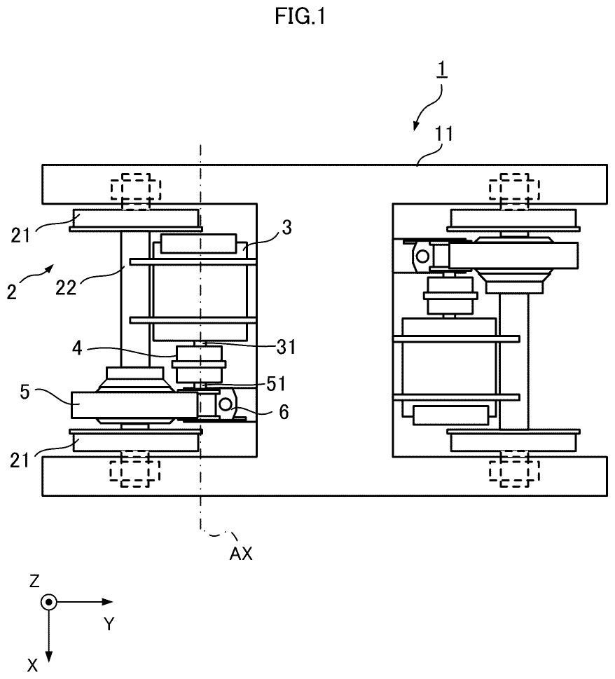

As illustrated in FIG. 1, a railway vehicle includes a bogie 1 with a bogie frame 11 supporting the body of the railway vehicle, wheel units 2 that allow the railway vehicle to travel, electric motors 3 that generate power to rotate the wheel units 2, flexible shaft couplings 4 that receive power from the electric motors 3, gear devices 5 that transmit power from the flexible shaft couplings 4 to the wheel units 2, and hangers 6 that restrict shaking motion of the gear devices 5. The wheel units 2, the electric motors 3, the flexible shaft couplings 4, the gear devices 5, and the hangers 6 are mount on the bogie 1.

Each wheel unit 2 includes wheels 21 that come in contact with a traveling surface and an axle 22 supporting the wheels 21. The axle 22 is supported by the bogie frame 11 with an axial spring.

Each electric motor 3 is fixed to the bogie frame 11. The electric motor 3 receives alternating current (AC) power with adjusted parameters such as a current value and a frequency. The electric motor 3 receiving AC power rotates to generate power. The electric motor 3 has a drive shaft 31 that outputs the generated power outside. The drive shaft 31 is connected to the flexible shaft coupling 4 to transmit power from the electric motor 3 to the flexible shaft coupling 4. In the example described below, the vertical direction is referred to as the Z-axis direction. The direction parallel to a central axis AX of the drive shaft 31 of the electric motor 3 extending horizontally when the railway vehicle is stopped horizontally is referred to as the X-axis direction. The direction perpendicular to the Z-axis direction and the X-axis direction is referred to as the Y-axis direction.

The flexible shaft coupling 4 is located between the electric motor 3 and the gear device 5. The flexible shaft coupling 4 transmits power from the electric motor 3 to the gear device 5.

The gear device 5 is supported by the bogie frame 11 with the hanger 6. The gear device 5 has a driven shaft 51 connected to the flexible shaft coupling 4 to receive power from the flexible shaft coupling 4. The gear device 5 includes, for example, a reducer including multiple gears with different numbers of teeth. The gear device 5 receives power with the driven shaft 51 and transmits the power to the axle 22 to rotate the axle 22 and the wheels 21. This causes the railway vehicle to travel.

While the railway vehicle is traveling, the wheel unit 2, the gear device 5, or other components are displaced, for example, under disturbance vibrations from the traveling surface. This can cause misalignment between the driven shaft 51 of the gear device 5 and the drive shaft 31 of the electric motor 3.

The flexible shaft coupling 4 that transmits power from the electric motor 3 to the gear device 5 has flexibility and can accommodate misalignment between the driven shaft 51 and the drive shaft 31.

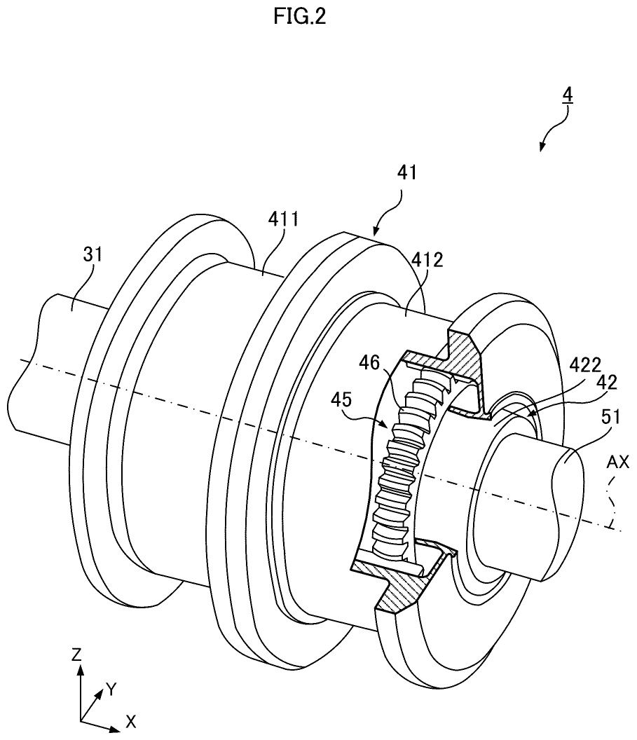

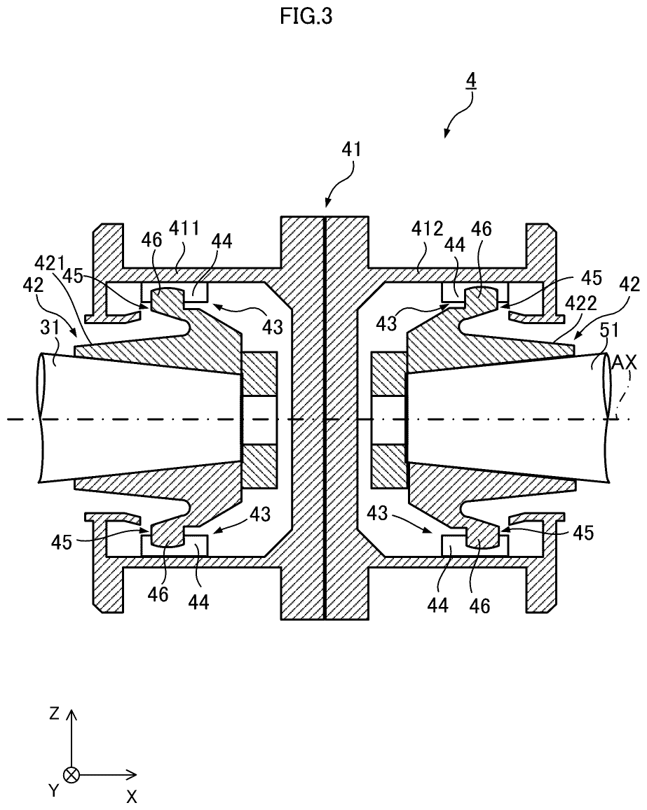

The structure of the flexible shaft coupling 4 is described with reference to FIGS. 2 and 3. FIG. 2 is a perspective view of the flexible shaft coupling 4. FIG. 2 illustrates the flexible shaft coupling 4 partially cut away. FIG. 3 is a schematic cross-sectional view of the flexible shaft coupling 4 taken along the central axis AX of the drive shaft 31.

The flexible shaft coupling 4 includes an outer tubular unit 41 and an inner tubular unit 42 inside the outer tubular unit 41.

The outer tubular unit 41 includes a first outer sleeve 411 adjacent to the drive shaft 31 and a second outer sleeve 412 adjacent to the driven shaft 51. The first outer sleeve 411 and the second outer sleeve 412 are fastened together with fasteners such as bolts.

As illustrated in FIG. 3, each of the first outer sleeve 411 and the second outer sleeve 412 includes an annular internal gear 43 along the inner circumference. The internal gear 43 is an example of a second gear. The internal gear 43 has internal teeth 44 protruding inside the outer tubular unit 41.

The inner tubular unit 42 includes a first inner sleeve 421 in which the drive shaft 31 is fitted and a second inner sleeve 422 in which the driven shaft 51 is fitted. Each of the first inner sleeve 421 and the second inner sleeve 422 is open at both ends.

Each of the first inner sleeve 421 and the second inner sleeve 422 includes an annular external gear 45 along the outer circumference. The external gear 45 is an example of a first gear. The external gear 45 has external teeth 46 protruding outward from the inner tubular unit 42.

The external gear 45 on the first inner sleeve 421 meshes with the internal gear 43 on the first outer sleeve 411. The external gear 45 on the second inner sleeve 422 meshes with the internal gear 43 on the second outer sleeve 412.

In the above structure, when the drive shaft 31 of the electric motor 3 rotates, the external gear 45 on the first inner sleeve 421 fitted on the drive shaft 31 rotates integrally with the drive shaft 31. The rotation of the first inner sleeve 421 causes rotation of the first outer sleeve 411, with the external gear 45 on the first inner sleeve 421 meshing with the internal gear 43 on the first outer sleeve 411.

The first outer sleeve 411 is fastened to the second outer sleeve 412 with fasteners. The second outer sleeve 412 thus rotates integrally with the first outer sleeve 411. The internal gear 43 on the second outer sleeve 412 meshes with the external gear 45 on the second inner sleeve 422. The second inner sleeve 422 thus rotates as the second outer sleeve 412 rotates.

When the second inner sleeve 422 rotates, the driven shaft 51 fitted in the second inner sleeve 422 rotates integrally with the second inner sleeve 422. In the above structure, the power is transmitted from the electric motor 3 through the flexible shaft coupling 4 to the gear device 5, as described with reference to FIG. 1.

To accommodate misalignment while the railway vehicle is traveling, the inner tubular unit 42 is inclined with respect to the outer tubular unit 41 in the flexible shaft coupling 4. More specifically, the central axis of the inner tubular unit 42 is inclined with respect to the central axis of the outer tubular unit 41. The inner tubular unit 42 being inclined with respect to the outer tubular unit 41 is hereafter referred to as being in a displaced state. The flexible shaft coupling 4 accommodates a predetermined range of angles of such inclination. The flexible shaft coupling 4 being inclined by a maximum allowable angle is hereafter referred to as being in a maximumly displaced state.

In the flexible shaft coupling 4, each internal tooth 44 and each external tooth 46 have profiles different from each other to suppress a decrease in the contact area between the internal tooth 44 and the external tooth 46 in the displaced state.

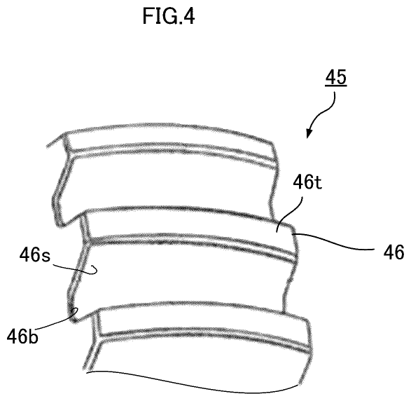

The structure of the internal tooth 44 and the external tooth 46 is described below in detail with reference to FIGS. 4 to 7.

FIG. 4 is a partial perspective view of the external gear 45 on the second inner sleeve 422 described with reference to FIG. 3. As illustrated in FIG. 4, each external tooth 46 is in the shape of an isosceles trapezoid when viewed in the tooth trace direction. The external tooth 46 is thicker at a tooth root 46b than at a tooth tip 46t. The external tooth 46 is crowned, or specifically has the surface of the tooth tip 46t and a tooth surface 46s each bulging in the center.

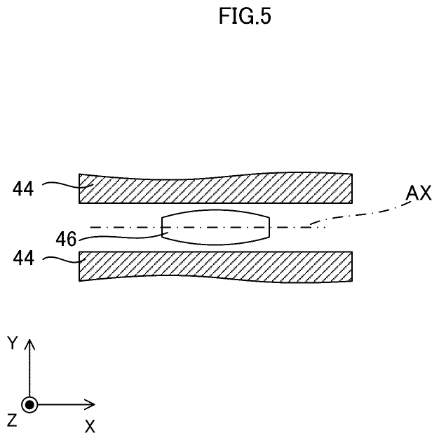

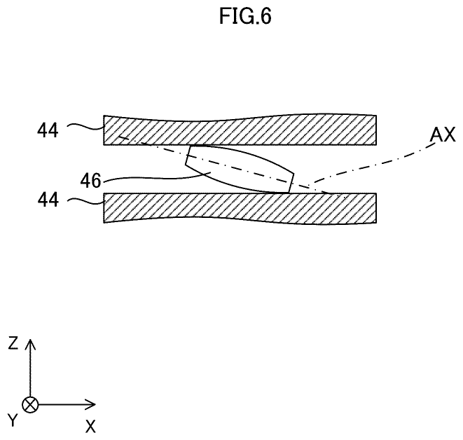

FIGS. 5 and 6 each schematically illustrate the positional relationship between the external tooth 46 of the external gear 45 on the first inner sleeve 421 and the internal tooth 44 of the internal gear 43 on the first outer sleeve 411 in the maximumly displaced state in which the central axis of the inner tubular unit 42, specifically, the central axis of the first inner sleeve 421 is inclined with respect to the central axis of the outer tubular unit 41 by the maximum allowable angle. In this state, the end of the first inner sleeve 421 in the negative X-axis direction in FIG. 3 is displaced in the positive Z-axis direction, and the end of the first inner sleeve 421 in the positive X-axis direction in FIG. 3 is displaced in the negative Z-axis direction. FIG. 5 is a diagram, viewed in the negative Z-axis direction, of the external tooth 46 and the internal tooth 44 located in an upper portion in the vertical direction. FIG. 6 is a diagram, viewed in the positive Y-axis direction, of the external tooth 46 and the internal tooth 44 located at the end in the negative Y-axis direction. In FIGS. 5 and 6, the external gear 45 rotates upward.

In FIG. 5, the external tooth 46 is closer to the internal tooth 44 in a central portion of the external tooth 46 in the tooth trace direction, or in other words, in the X-axis direction. This positional relationship also applies to the external tooth 46 and the internal tooth 44 located in a lower portion in the vertical direction. In a non-displaced state in which the central axis of the inner tubular unit 42 is not inclined with respect to the central axis of the outer tubular unit 41, the external teeth 46 and the internal teeth 44 are all in the same positional relationship as in FIG. 5. More specifically, each external tooth 46 is closer to the corresponding internal tooth 44 in the central portion of the external tooth 46 in the tooth trace direction.

In the maximumly displaced state, as illustrated in FIG. 6, the external tooth 46 located at the end in the negative Y-axis direction is in contact with the internal tooth 44 at a point near the end of the external tooth 46 in the tooth trace direction.

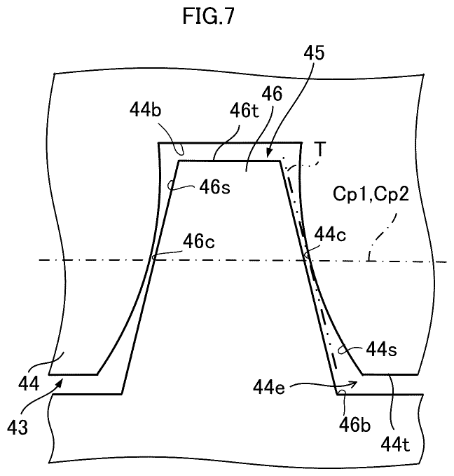

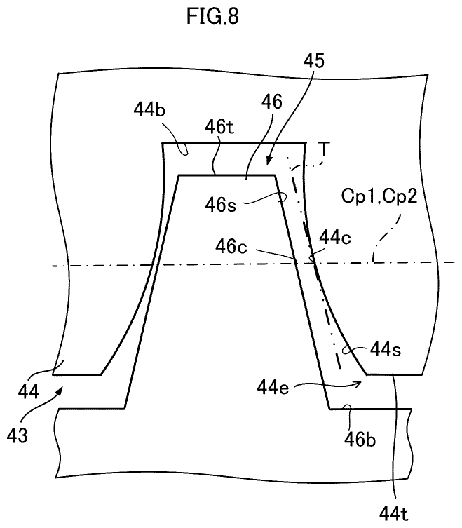

FIG. 7 is a schematic cross-sectional view of the internal tooth 44 and the external tooth 46 described with reference to FIG. 6. More specifically, FIG. 7 illustrates a cross section of the external tooth 46 perpendicular to the tooth trace direction and including the central portion of the external tooth 46 in the tooth trace direction in the non-displaced state. FIG. 8 is a schematic cross-sectional view of the internal tooth 44 and the external tooth 46 described with reference to FIG. 6. FIG. 8 illustrates a cross section of the external tooth 46 perpendicular to the tooth trace direction and including a point of contact between the external tooth 46 and the internal tooth 44 near the end of the external tooth 46 in the tooth trace direction. The cross sections are hereafter not hatched.

The pitch circle of each gear is hereafter indicated by a dot-dash line. For easy understanding, the pitch circles are linear in the enlarged drawings. The pitch circle of the external gear 45 is referred to as an external-tooth pitch circle Cp1. The pitch circle of the internal gear 43 is referred to as an internal-tooth pitch circle Cp2. A point on the external-tooth pitch circle Cp1 of the external tooth 46, or in other words, a pitch point of the external tooth 46, is referred to as an external-tooth pitch point 46c. A point on the internal-tooth pitch circle Cp2 of the internal tooth 44, or in other words, a pitch point of the internal tooth 44, is referred to as an internal-tooth pitch point 44c. The flexible shaft coupling 4 has a backlash between the internal tooth 44 of the internal gear 43 and the external tooth 46 of the external gear 45 to allow, for example, misalignment or mechanical tolerance. The external tooth 46 and the internal tooth 44 each have a non-involute profile different from an involute profile created with an involute function.

As illustrated in FIGS. 7 and 8, the tooth surface 46s of the external tooth 46 is in the shape of a straight line when viewed in the tooth trace direction. In other words, the tooth surface 46s of the external tooth 46 is in the shape of a straight line in a cross section perpendicular to the tooth trace direction. The tooth surface 46s of the external tooth 46 is hereafter referred to as an external tooth surface 46s. The external tooth surface 46s is an example of a first tooth surface of the first gear.

The internal tooth 44 has a profile different from the profile of the external tooth 46. The internal tooth 44 has a tooth surface 44s that is curved outward, or specifically in the shape of an arc, when viewed in the tooth trace direction. More specifically, the tooth surface 44s of the internal tooth 44 is in the shape of an arc protruding toward the external tooth 46 in a cross section perpendicular to the tooth trace direction. The tooth surface 44s of the internal tooth 44 is hereafter referred to as an internal tooth surface 44s. The internal tooth surface 44s is an example of a second tooth surface of the second gear.

More specifically, the internal tooth surface 44s is in the shape of a partial circumference of a circle having a tangent T extending through the internal-tooth pitch point 44c when viewed in the tooth trace direction. The tangent T is hereafter indicated by a two-dot-dash line.

The tangent T is parallel to the adjacent external tooth surface 46s of the external tooth 46, or in other words, parallel to the external tooth surface 46s facing the internal tooth surface 44s touched by the tangent T. In other words, the internal tooth surface 44s is in the shape of an arc having a tangent parallel to the external tooth surface 46s when viewed in the tooth trace direction.

The internal tooth surface 44s is closest to the external tooth surface 46s at the internal-tooth pitch point 44c and is gradually farther from the external tooth surface 46s from the internal-tooth pitch point 44c toward a tooth root 44b and a tooth tip 44t of the internal tooth 44.

The internal tooth surface 44s of the internal tooth 44 is, in a cross section perpendicular to the tooth trace direction, curved outward and is closest to the facing external tooth surface 46s at the internal-tooth pitch point 44c. More specifically, the internal tooth surface 44s in the cross section is in the shape of an arc having the tangent T extending through the internal-tooth pitch point 44c and parallel to the external tooth surface 46s of the external tooth 46. In other words, the tangent T extends through the internal-tooth pitch point 44c and parallel to a straight line corresponding to the external tooth surface 46s of the external tooth 46 in a cross section perpendicular to the tooth trace direction. This avoids contact between an edge 44e of the tooth tip 44t and the external tooth 46 in the maximumly displaced state, as illustrated in FIG. 8. This thus suppresses a decrease in the contact area between the internal tooth surface 44s and the external tooth surface 46s, suppressing the contact stress between the internal tooth 44 and the external tooth 46.

The internal tooth surface 44s of the internal gear 43 is in the shape of an arc when viewed in the tooth trace direction as described above. With this structure, when the contact stress between the internal tooth 44 and the external tooth 46 is greater, the internal tooth surface 44s and the external tooth surface 46s come in contact with each other with a larger contact area between these surfaces, with the internal tooth 44 elastically deformed. This structure can thus suppress the contact stress between the internal tooth 44 and the external tooth 46 as compared with when the internal tooth surface 44s of the internal gear 43 has a shape other than an arc shape when viewed in the tooth trace direction.

In the present embodiment, the contact stress at a contact position between the internal tooth 44 and the external tooth 46 may be adjusted by adjusting the relative curvature radiuses of the internal tooth 44 and the external tooth 46 at the contact position. More specifically, the internal tooth 44 and the external tooth 46 may have greater relative curvature radiuses to reduce the contact stress at the contact position.

The reduced contact stress can relax the extreme pressure and thus reduce the frictional heat. This can eliminate vibrations of the internal gear 43 and the external gear 45 meshing with each other, thus reducing vibrations and noise.

With a decrease in the contact area being suppressed, the flexible shaft coupling 4 can accommodate greater displacement. This increases the design flexibility in the peripheral devices.

With the contact stress being suppressed, the flexible shaft coupling 4 has less wear and thus has a longer life.

The shapes of the internal tooth surface 44s and the external tooth surface 46s may be modified as appropriate for the inclination angle to be accommodated by the flexible shaft coupling 4.

The internal tooth surface 44s of the internal tooth 44 and the external tooth surface 46s of the external tooth 46 are both in the shape of a straight line or curved outward, rather than being curved inward, when viewed in the tooth trace direction, and at least one of the internal tooth surface 44s of the internal tooth 44 or the external tooth surface 46s of the external tooth 46 is curved outward when viewed in the tooth trace direction. For example, at least one of the internal tooth surface 44s of the internal tooth 44 or the external tooth surface 46s of the external tooth 46 may have any outward curved shape other than an arc shape when viewed in the tooth trace direction. More specifically, in a cross section perpendicular to the tooth trace direction, the internal tooth surface 44s may be simply closest to the external tooth surface 46s at the internal-tooth pitch point 44c, or the external tooth surface 46s may be simply closest to the internal tooth surface 44s at the external-tooth pitch point 46c.

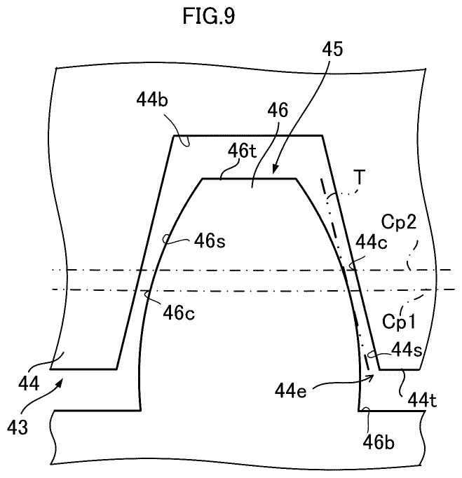

As illustrated in FIG. 9, the internal tooth surface 44s of the internal tooth 44 may be in the shape of a straight line when viewed in the tooth trace direction, and the external tooth surface 46s of the external tooth 46 may be curved outward when viewed in the tooth trace direction. The external tooth surface 46s of the external tooth 46 is preferably in the shape of an arc bulging toward the internal tooth surface 44s of the internal tooth 44 when viewed in the tooth trace direction.

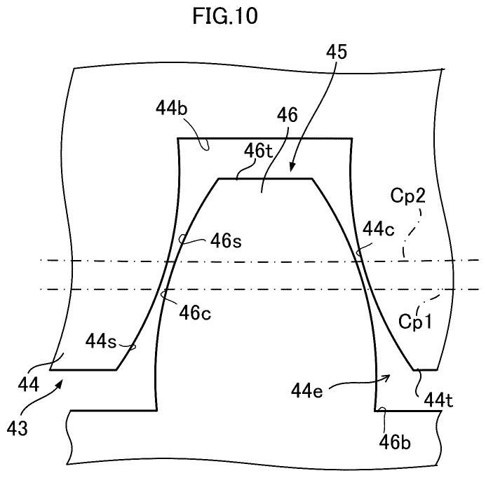

In the embodiment, as illustrated in FIG. 10, the internal tooth surface 44s and the external tooth surface 46s may be both curved outward toward each other. More specifically, in a cross section perpendicular to the tooth trace direction, the internal tooth surface 44s may be in the shape of an arc bulging toward the facing external tooth surface 46s, and the external tooth surface 46s may be in the shape of an arc bulging toward the facing internal tooth surface 44s. When the internal tooth surface 44s and the external tooth surface 46s are both in the shape of arcs in a cross section perpendicular to the tooth trace direction, the curvature radiuses of these arcs may be the same or may be different from each other. In a cross section perpendicular to the tooth trace direction, the arcs of the internal tooth surface 44s and the external tooth surface 46s may have the curvature radiuses adjusted as appropriate for the contact stress to be accommodated.

In the above embodiment described above, the internal tooth surface 44s is closest to the external tooth surface 46s at the internal-tooth pitch point 44c. However, the internal tooth 44 may have any other structure that can avoid contact between the edge 44e and the external tooth 46. For example, the internal tooth surface 44s may be closest to the external tooth surface 46s near the internal-tooth pitch point 44c. In other words, the tangent T may extend through a point near the internal-tooth pitch point 44c on the internal tooth surface 44s, rather than through the internal-tooth pitch point 44c.

The tangent T may be parallel to the external tooth surface 46s facing the internal tooth surface 44s touched by the tangent T in a displaced state in which the inclination angle is smaller than in the maximumly displaced state.

The direction in which the inner tubular unit 42 is displaced is not limited to the direction in the above example. In an example, the end of the first inner sleeve 421 in the negative X-axis direction in FIG. 3 may be displaced in the negative Z-axis direction, and the end of the first inner sleeve 421 in the positive X-axis direction in FIG. 3 may be displaced in the positive Z-axis direction.

In the above embodiments, the shapes of the internal tooth 44 on the first outer sleeve 411 and the external tooth 46 on the first inner sleeve 421 have been described with reference to FIGS. 4 to 8. The shapes of the internal tooth 44 and the external tooth 46 described with reference to FIGS. 4 to 8 may also apply to the internal tooth 44 on the second outer sleeve 412 and the external tooth 46 on the second inner sleeve 422.

### Embodiment 2

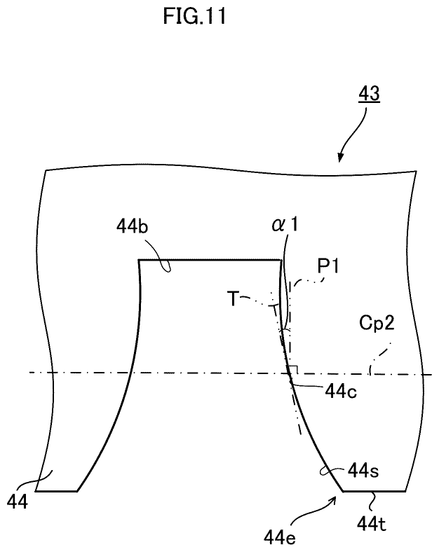

A flexible shaft coupling 4 according to Embodiment 2 is described with reference to FIGS. 11 to 14. The basic structure and the basic operation of the flexible shaft coupling 4 according to Embodiment 2 are the same as or similar to the basic structure and the basic operation of the flexible shaft coupling 4 according to Embodiment 1. However, unlike in Embodiment 1, the internal tooth 44 of the internal gear 43 and the external tooth 46 of the external gear 45 have pressure angles different from each other to more reliably restrict contact between the edge 44e of the internal tooth surface 44s and the external tooth surface 46s. Embodiment 2 is described focusing on the differences from Embodiment 1. A perpendicular to the pitch circle of each gear at a pitch point is hereafter indicated by a two-dot-dash line.

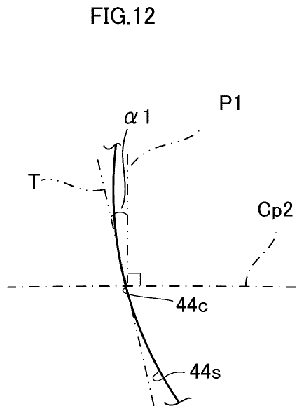

FIG. 11 is a diagram of the internal tooth 44 of the internal gear 43. FIG. 12 is a diagram of the internal tooth 44 in FIG. 11, illustrating the internal-tooth pitch point 44c and a nearby area in an enlarged manner.

As illustrated in FIGS. 11 and 12, the internal tooth 44 has a pressure angle α1 formed by the tangent T at the internal-tooth pitch point 44c internal-tooth and a perpendicular P1 to the internal-tooth pitch circle Cp2. The pressure angle α1 of the internal tooth 44 is hereafter referred to as an internal-tooth pressure angle α1.

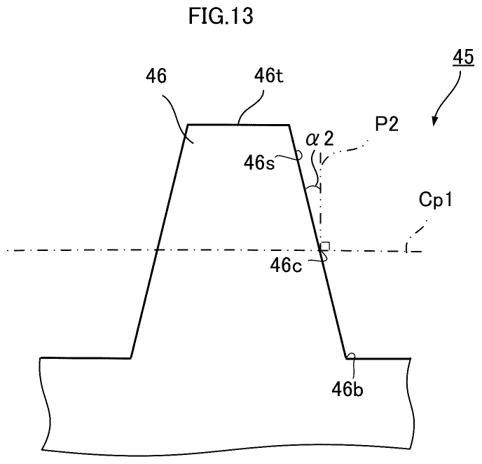

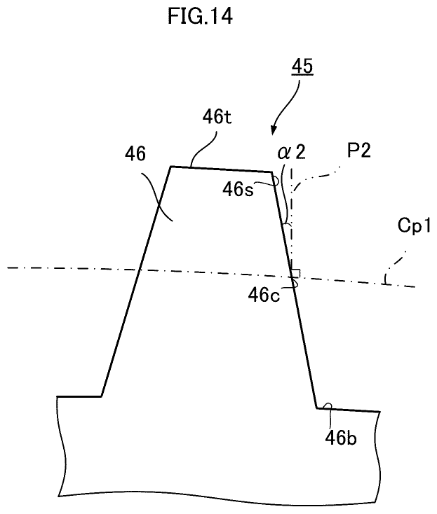

FIGS. 13 and 14 are each a diagram of the external tooth 46 of the external gear 45. As illustrated in FIG. 13, the external tooth 46 has a pressure angle α2 formed by the external tooth surface 46s and a perpendicular P2 to the external-tooth pitch circle Cp1 at the external-tooth pitch point 46c on the external-tooth pitch circle Cp1. The pressure angle α2 of the external tooth 46 is hereafter referred to as an external-tooth pressure angle α2.

As illustrated in FIGS. 13 and 14, for example, the external-tooth pressure angle α2 of the external tooth 46 decreases with rotation of the external gear 45. In the drawings, the external tooth 46 rotates clockwise.

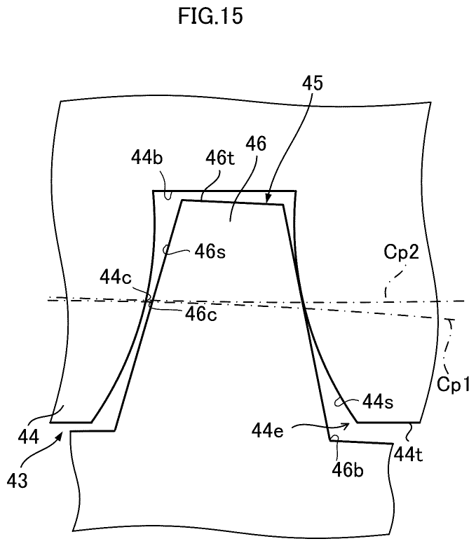

In the present embodiment, the external pressure angle α2 of the external tooth 46 decreases with rotation of the external gear 45, and thus the external pressure angle α2 of the external tooth 46 is preset to a value greater than the value of the internal-tooth pressure angle α1 of the internal tooth 44. The external-tooth pressure angle α2 is set by the designer to the value acquired by, for example, adding the external-tooth pressure angle α2 that decreases with rotation of the external tooth 46 to the internal-tooth pressure angle α1 of the internal tooth 44. The tangent to the internal tooth surface 44s at the point of contact with the external tooth surface 46s is thus parallel to the external tooth surface 46s when the external tooth 46 is inclined to decrease the external-tooth pressure angle α2, as illustrated in FIG. 15. This restricts contact between the edge 44e of the internal tooth surface 44s and the external tooth surface 46s.

The present disclosure is not limited to the embodiments described above and may be implemented in other embodiments with modifications as appropriate.

In the embodiments of the present disclosure, for example, the external-tooth pressure angle α2 of the external tooth 46 is set greater than the internal-tooth pressure angle α1 of the internal tooth 44 to restrict contact between the edge 44e of the internal tooth 44 and the external tooth surface 46s. Instead, the curvature radius of the arc of the internal tooth surface 44s may be set to a further less value. This restricts contact between the edge 44e of the internal tooth 44 and the external tooth surface 46s.

In the embodiments of the present disclosure, the external gear 45 rotates clockwise. However, the external gear 45 may rotate counterclockwise. In this case, the drawings described in Embodiments 1 and 2 are modified as appropriate for the rotation direction of the external gear 45. For example, the inclinations of the right and left sides of the external tooth 46 in FIGS. 14 and 15 are interchanged.

The flexible shaft coupling 4 may be used for any structure other than railway vehicles that transmits power from the drive shaft of an electric motor to a driven shaft.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Bogie
2 Wheel unit
3 Electric motor
4 Flexible shaft coupling
5 Gear device
6 Hanger
11 Bogie frame
21 Wheel
22 Axle
31 Drive shaft
41 Outer tubular unit
42 Inner tubular unit
43 Internal gear
44 Internal tooth
44b Tooth root
44c Internal-tooth pitch point (pitch point of internal tooth)
44e Edge
44s Internal tooth surface (tooth surface of internal tooth)
44t Tooth tip
45 External gear
46 External tooth
46b Tooth root
46c External-tooth pitch point (pitch point of external tooth)
46s External tooth surface (tooth surface of external tooth)
46t Tooth tip
51 Driven shaft
411 First outer sleeve
412 Second outer sleeve
421 First inner sleeve
422 Second inner sleeve
AX Central axis
Cp1 External-tooth pitch circle (pitch circle of external tooth)
Cp2 Internal-tooth pitch circle (pitch circle of internal tooth)
α1 Internal-tooth pressure angle (pressure angle of internal tooth)
α2 External-tooth pressure angle (pressure angle of external tooth)
P1, P2 Perpendicular
T Tangent

1. A flexible shaft coupling, comprising:
a first gear that is an external gear; and
a second gear that is an internal gear meshing with the first gear, wherein
the first gear has a first tooth surface that is an external tooth surface, the first tooth surface being in a shape of a straight line when viewed in a tooth trace direction, and
the second gear has a second tooth surface that is an internal tooth surface, the second tooth surface being curved outward when viewed in the tooth trace direction.

2. The flexible shaft coupling according to claim 1, wherein
at least one of the first tooth surface or the second tooth surface is in a shape of an arc when viewed in the tooth trace direction.

3. The flexible shaft coupling according to claim 1, wherein
the first tooth surface is in a shape of a straight line when viewed in the tooth trace direction, and the second tooth surface is in a shape of an arc having a tangent parallel to the straight line when viewed in the tooth trace direction.

4.-7. (canceled)

8. The flexible shaft coupling according to claim 2, wherein
the first tooth surface is in a shape of a straight line when viewed in the tooth trace direction, and the second tooth surface is in a shape of an arc having a tangent parallel to the straight line when viewed in the tooth trace direction.

9. The flexible shaft coupling according to claim 3, wherein
the tangent extends through a point on a pitch circle of the second gear and parallel to the straight line.

10. The flexible shaft coupling according to claim 8, wherein
the tangent extends through a point on a pitch circle of the second gear and parallel to the straight line.

11. The flexible shaft coupling according to claim 1, wherein
the first tooth surface and the second tooth surface have pressure angles different from each other.

12. The flexible shaft coupling according to claim 2, wherein
the first tooth surface and the second tooth surface have pressure angles different from each other.

13. The flexible shaft coupling according to claim 3, wherein
the first tooth surface and the second tooth surface have pressure angles different from each other.

14. The flexible shaft coupling according to claim 9, wherein
the first tooth surface and the second tooth surface have pressure angles different from each other.

15. The flexible shaft coupling according to claim 1, wherein
the first tooth surface has a greater pressure angle than a pressure angle of the second tooth surface.

16. The flexible shaft coupling according to claim 2, wherein
the first tooth surface has a greater pressure angle than a pressure angle of the second tooth surface.

17. The flexible shaft coupling according to claim 3, wherein
the first tooth surface has a greater pressure angle than a pressure angle of the second tooth surface.

18. The flexible shaft coupling according to claim 9, wherein
the first tooth surface has a greater pressure angle than a pressure angle of the second tooth surface.

19. The flexible shaft coupling according to claim 11, wherein
the first tooth surface has a greater pressure angle than the pressure angle of the second tooth surface.

20. A flexible shaft coupling, comprising:
a first gear; and
a second gear meshing with the first gear, wherein
the first gear has a first tooth surface, the second gear has a second tooth surface, and at least one of the first tooth surface or the second tooth surface is curved outward when viewed in a tooth trace direction, and
the first tooth surface and the second tooth surface have pressure angles different from each other.

21. The flexible shaft coupling according to claim 20, wherein
the first tooth surface has a greater pressure angle than the pressure angle of the second tooth surface.

22. The flexible shaft coupling according to claim 20, wherein
the first gear is an external gear, and the second gear is an internal gear.

23. The flexible shaft coupling according to claim 21, wherein
the first gear is an external gear, and the second gear is an internal gear.
